(19) United States
(12) Patent Application Publication
(10) Pub. No.: US 2007/0081258 A1
(43) Pub. Date: Apr. 12, 2007

(54) Imaging lens array

(75) Inventor: Yeo-Chih Huang, Taichung (TW)

Correspondence Address: CHARLES E. BAXLEY, ESQ., 90 JOHN STREET, THIRD FLOOR, NEW YORK, NY, 10038, US

(73) Assignee: Largan Precision Co. Ltd.

(21) Appl. No.: 11/245,821

(22) Filed: Oct. 7, 2005

(51) Int. Cl. G02B 13/18

(52) U.S. Cl. 359/715

(57) ABSTRACT

The present invention relates to a compact and high resolution imaging lens array that comprises successively from the object side: a first positive lens is a meniscus plastic lens with a concave surface facing forward, a second glass biconvex lens, a third negative lens is a meniscus lens with a concave surface facing forward, a fourth positive lens is a biconvex lens made of plastic, and an aperture is located between the first lens and the second lens. The respective lenses are provided with aspherical surface, and thus the size of the imaging lens array can be reduced and the resolution also can be improved.

### BACKGROUND OF THE INVENTION

1. Field of the Invention

The present invention relates to a lens array used on a digital camera, and more particularly to an imaging lens array consisted of four lenses, wherein the aperture is arranged at the center of the imaging lens array.

2. Description of the Prior Art

The light sensitivity of a digital camera (DC) with fixed focus lens array will be reduced sharply with the increase of exit angle of the lens. Therefore, the digital fixed focus lens array is usually arranged in an inverse telephoto manner for prevention of shading problem. In practical application, the digital fixed focus lens array generally comprises 5-6 lenses, wherein the first lens is a negative meniscus lens with a concave surface facing forward. However, this type lens arrays still have some technical defects as follows:

First, in order to reduce the exit angle of the lens array, the smaller the radius of curvature of the rear surface of the first lens is, the better. However, the problem associated with this design is that the height of the optical system will be increased, and thus the radius of curvature of the first lens can't be reduced infinitely. Therefore, most of the existing optical system are about 18-22 mm high and can't be reduced in height any more.

Second, the three order aberration and the stray light problem will worsen as the radius of curvature of the digital fixed focus lens array increases, so that more lenses need to be arranged behind the digital fixed focus lens array to correct the aforementioned problems.

In some cases, the digital fixed focus lens array will use aspherical plastic lens to overcome the aberration and in order to reduce number of lenses. However, the plastic lens has the problem of thermal effect, in practical terms, only the first lens and the last lens of the digital fixed focus lens array can be replaced by the aspherical plastic lens, but this only can solve the aberration problem but help little in reducing the whole size of the optical system.

The present invention has arisen to mitigate and/or obviate the afore-described disadvantages.

### SUMMARY OF THE INVENTION

The primary objective of the present invention is to provide a compact and high resolution imaging lens array that comprises successively from the object side: a first positive lens is a meniscus plastic lens with a concave surface facing forward, a second glass biconvex lens, a third negative lens is a meniscus lens with a concave surface facing forward, a fourth positive lens is a biconvex lens made of plastic, and an aperture is located between the first lens and the second lens. The respective lenses are provided with aspherical surface, and thus the size of the imaging lens array can be reduced and the resolution also can be improved.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a schematic view of showing an imaging lens array in accordance with a first embodiment of the present invention;

FIG. 2 is a curve diagram for showing the aberration correction of the first embodiment of the present invention;

FIG. 3 is a schematic view of showing an imaging lens array in accordance with a second embodiment of the present invention;

FIG. 4 is a curve diagram for showing the aberration correction of the second embodiment of the present invention;

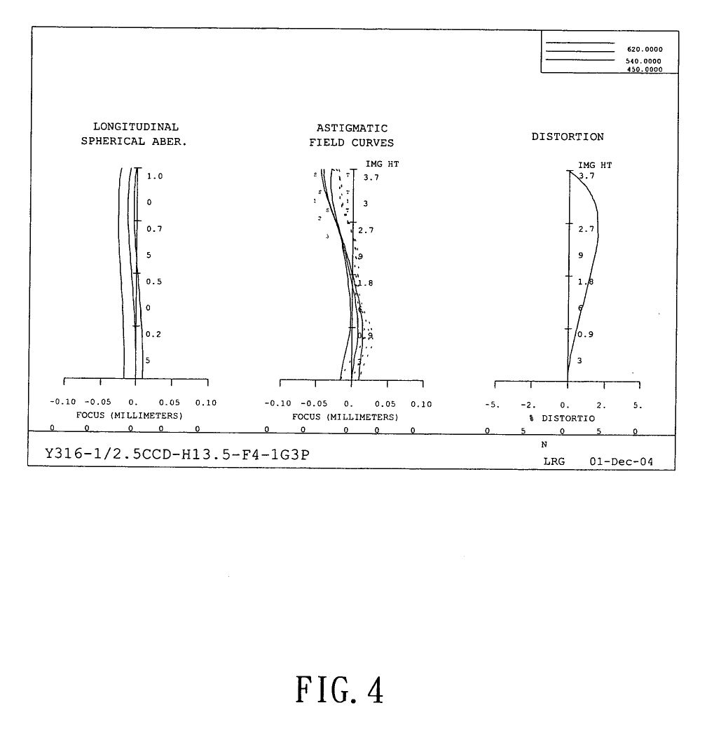

Table 1 shows the optical data of the first embodiment of the present invention; and

Table 2 shows the optical data of the second embodiment of the present invention.

### DETAILED DESCRIPTION OF THE PREFERRED EMBODIMENTS

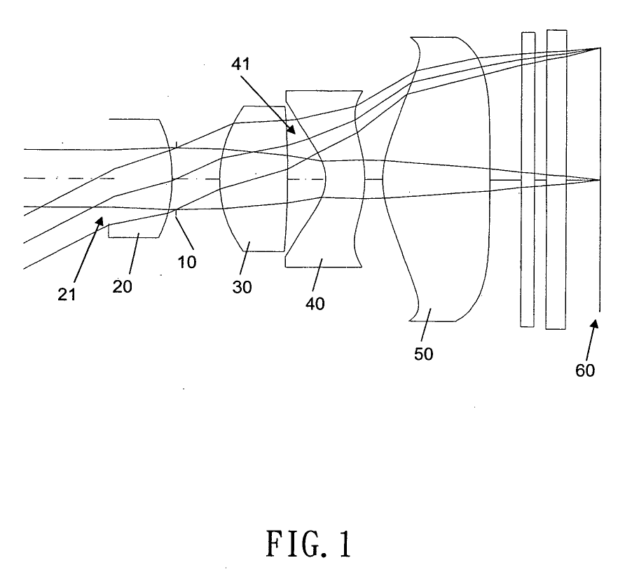

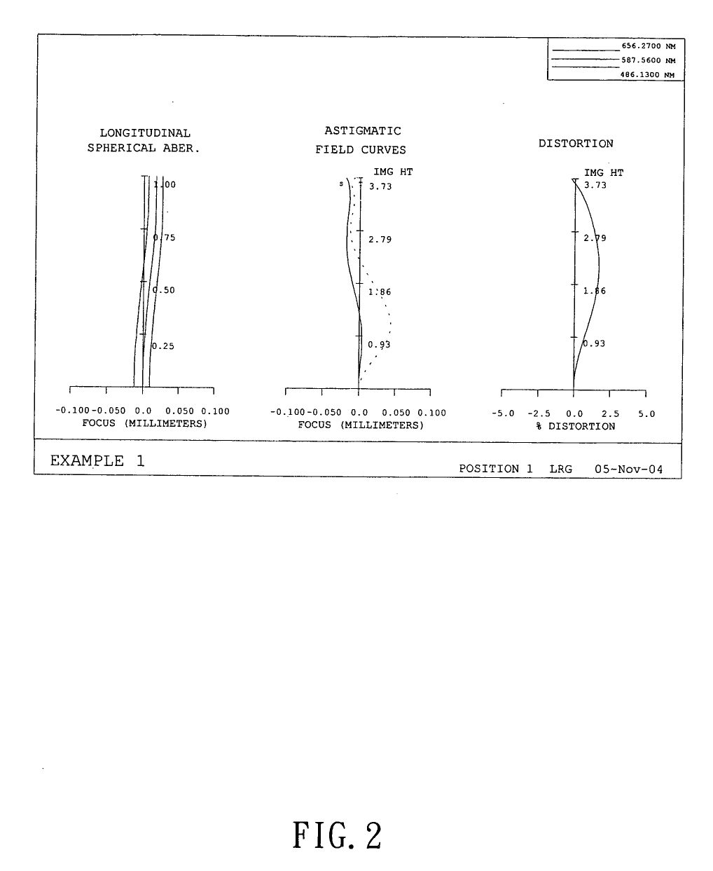

Referring to FIGS. 1 and 2, an imaging lens array in accordance with a first embodiment of the present invention comprises a front group and a rear group. The front group is a first lens 20, and the rear group includes a second lens 30, a third lens 40 and a fourth lens 50 arranged in sequence.

The first lens 20 is a meniscus aspherical lens with a concave surface 21 facing forward. The focal length f1 of the first lens 20 and the focal length of the entire imaging lens array (the optical system) f satisfy the equation as: −0.5<|f/f1|<0.5.

An aperture 10 is located at a central position between the front and rear groups, and most of the refractive power of the imaging lens array is provided by the rear group, the aperture 10 is arranged behind the first lens 20.

The second lens 30 is a biconvex glass lens, and the radius of curvature of its front and rear surfaces are R1 and R2 that satisfy the equation as: |R1/R2|<0.5. The focal length f2 of the second lens 30 and the focal length of the imaging lens array (the optical system) f satisfy the equation as: 0.5<|f/f2|<2.0, so that it can efficiently reduce the spherical aberration.

The third lens 40 is a plastic made meniscus aspherical lens with a concave surface 41 facing forward, and the focal length and the color aberration of the third lens 40 are f3 and V3 that satisfy the relation as: |f3/f|<1.0, and V3<35. The thickness t3 of the third lens 40 satisfy the relation as: 0.5 mm<t3<2.0 mm.

The fourth lens 50 is a plastic aspherical lens with a convex surface facing forward. The third lens 40 has a negative refractive power and the fourth lens 50 has a positive refractive power.

The imaging lens array in accordance with the present invention comprises, successively from the object side, the first lens 20, the aperture 10, the second lens 30, the third lens 40 and the fourth lens 50 and an image plane 60. The first lens 20 is a meniscus aspherical lens whose concave surface 21 facing forward and has a positive refractive power, so it can be used to balance the astigmatic aberration and curvature of field caused by the respective lenses of the rear group. The focal length f1 of the first lens 20 and the focal length of the imaging lens array f satisfy the equation: −0.5<|f/f1|<0.5, and thus the refractive power of the first lens 20 can be reduced, this helps solve the thermal effect problem.

The aperture 10 is disposed between at the center position between the front and rear groups, and most of the refractive power of the imaging lens array is provided by the rear group, the aperture 10 is arranged behind the first lens 20, and the aperture 10 is located behind the first lens 2. Such arrangements can effectively suppress the occurrence of stray light.

The second lens 30 is a biconvex glass lens, and the radius of curvature of its front and rear surfaces are R1 and R2 that satisfy the equation : |R1/R2|<0.5, so that it can efficiently reduce the spherical aberration. Besides, the focal length f2 of the second lens 30 and the focal length of the imaging lens array (the optical system) f satisfy the equation as: 0.5<|f/f2|<2.0, and this is helpful in reducing the refractive power and solving the thermal effect of the plastic lens.

The third lens 40 is a plastic made meniscus aspherical lens with a concave surface 41 facing forward, and the focal length and the color aberration of the third lens 40 are f3 and V3 that satisfy the relation as: |f3/f|<1.0, and V3<35, so that the third lens 40 will have enough refractive power and effective compensation color aberration. In addition, the thickness t3 of the third lens 40 satisfy the relation as: 0.5 mm<t3<2.0 mm, this is helpful in reduction of residual stress and image aberration of the third lens 40.

The fourth lens 50 is a plastic aspherical lens with a convex surface facing forward, the third lens 40 has a negative refractive power and the fourth lens 50 has a positive refractive power, such arrangements can help solve the aberration and coma.

The imaging lens array in accordance with the present invention can be reduced to less than 14 mm, furthermore, its resolution is improved and the thermal effect can be suppressed effectively. The optical data of the first embodiment is shown in table 1.

It is to be noted that the data as shown in table 1 is for reference only and subject to change depending upon the structure, arrangement and other conditions of the image lens array.

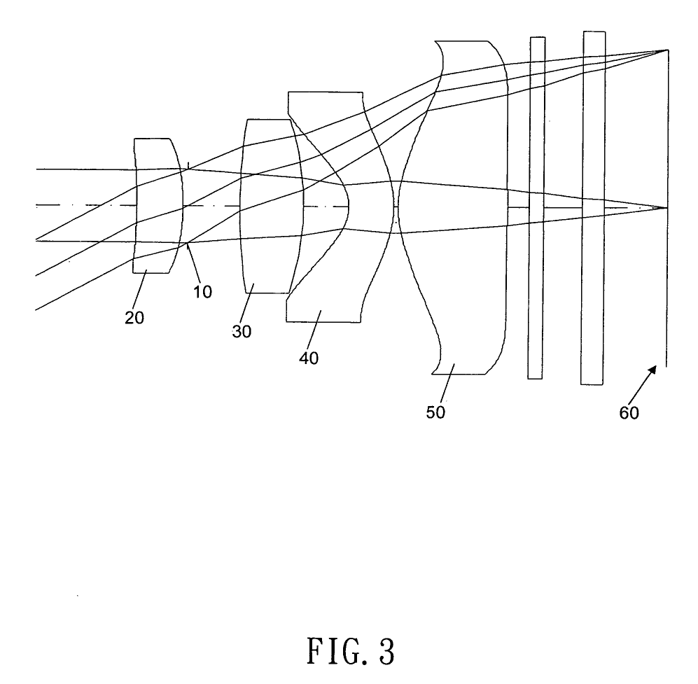

An imaging lens array in accordance with a second embodiment of the present invention is shown in FIG. 3 and comprises successively from the object side to the image plane 60:

The first lens 20 is a meniscus aspherical lens with a concave surface facing forward and has a positive refractive power, and both rear and front surfaces of the first lens 20 are aspherical.

The second lens 30 is a biconvex glass lens having a positive refractive power, and two opposite surfaces of the second lens 30 are convex.

The third lens 40 is a plastic made meniscus aspherical lens with a concave surface facing forward and has a negative refractive power, and two opposite surfaces of the third lens 40 are aspherical;

The fourth lens 50 is biconvex plastic lens having a positive refractive power, and both rear and front surfaces of the fourth lens 50 are aspherical.

The aperture 10 is located between the first and second lenses. The optical data of the second embodiment is shown in table 2, since the lens array of the second embodiment is functionally the same as that of the first embodiment, further remarks on this matter will be omitted.

While we have shown and described various embodiments in accordance with the present invention, it should be clear to those skilled in the art that further embodiments may be made without departing from the scope of the present invention.

TABLE 1
The optical data of the first embodiment of the present invention

| | | | | | | | Focal |
|---|---|---|---|---|---|---|---|
| Surf# | | RDY | THI | Material | Index | Abbe # | length |
| 0 | OBJECT | PLANO | 1000 | | | | |
| *1 | Lens 1 | −6.257 | 1.457 | Plastic | 1.514 | 56.8 | 31.8 |
| *2 | | −4.800 | 0.100 | | | | |
| 3 | APE. | PLANO | 1.099 | | | | |
| | STOP | | | | | | |
| 4 | Lens 2 | 3.798 | 1.722 | Glass | 1.620 | 60.3 | 5.56 |
| 5 | | −31.12 | 0.981 | | | | |
| *6 | Lens 3 | −1.2199 | 1.000 | Plastic | 1.607 | 26.6 | −3.73 |
| *7 | | −3.465 | 0.462 | | | | |
| *8 | Lens 4 | 2.781 | 2.747 | Plastic | 1.514 | 56.8 | 5.20 |
| *9 | | −45.04 | 0.86 | | | | |
| 10 | IR-cut | PLANO | 0.33 | Glass | 1.517 | 64.2 | — |
| | filter | | | | | | |
| 11 | | PLANO | 0.3 | | | | |
| 12 | Cover | PLANO | 0.5 | Glass | 1.517 | 64.2 | — |
| | Glass | | | | | | |
| 13 | | PLANO | 0.8 | | | | |
| 14 | IMAGE | PLANO | | | | | |

| Surf# | R | K | A4 | A6 | A8 | A10 |
|---|---|---|---|---|---|---|
| 1 | −6.257 | −1.0 | −5.148E−3 | −4.966E−4 | — | — |
| 2 | −4.880 | −1.0 | −5.773E−3 | −2.013E−4 | — | — |
| 6 | −1.2199 | −1.115 | 5.834E−2 | −5.088E−3 | — | — |
| 7 | −3.465 | −0.614 | 1.073E−2 | 4.315E−3 | −3.741E−4 | — |
| 8 | 2.781 | −6.44 | 5.277E−4 | −4.929E−4 | 6.612E−5 | −2.906E−6 |
| 9 | −45.04 | −1.0 | 4.373E−3 | −1.166E−3 | 8.808E−5 | 2.669E−6 |

the focal length of the imaging lens array: f = 6.46, FNO = 4.0, HFOV = 30 deg
the first lens: f/f1 = 0.203
the second lens: f/f2 = 1.16, |R1/R2| = 0.122
the third lens: |f3/f| = 0.577, V3 = 26.6, t3 = 1.0 mm

TABLE 2
The optical data of the second embodiment of the present invention

| | | | | | | | Focal |
|---|---|---|---|---|---|---|---|
| Surf# | | RDY | THI | Material | Index | Abbe # | length |
| 0 | OBJECT | PLANO | 1000 | | | | |
| *1 | Lens 1 | −34.2516 | 1.063 | Plastic | 1.53 | 55.8 | 12.03 |
| *2 | | −5.4332 | 0.1 | | | | |
| 3 | APE. | PLANO | 1.2 | | | | |
| | STOP | | | | | | |
| 4 | Lens 2 | 13.7145 | 1.45 | Glass | 1.62 | 60.3 | 7.58 |
| 5 | | −6.8628 | 1.041 | | | | |
| *6 | Lens 3 | −0.89483 | 1.03 | Plastic | 1.607 | 26.6 | −3.15 |
| *7 | | −2.41142 | 0.1 | | | | |
| *8 | Lens 4 | 2.36505 | 2.5 | Plastic | 1.53 | 55.8 | 4.27 |
| *9 | | −32.895 | 0.5 | | | | |
| 10 | IR-cut | PLANO | 0.33 | Glass | 1.517 | 64.2 | — |
| | filter | | | | | | |
| 11 | | PLANO | 0.3 | | | | |
| 12 | Cover | PLANO | 0.5 | Glass | 1.517 | 64.2 | — |
| | Glass | | | | | | |
| 13 | | PLANO | 0.8 | | | | |
| 14 | IMAGE | PLANO | | | | | |

| Surf# | R | K | A4 | A6 | A8 | A10 |
|---|---|---|---|---|---|---|
| 1 | −34.2516 | −1.00000E+00 | −1.29212E−02 | −1.58197E−03 | — | — |
| 2 | −5.4332 | −1.00000E+00 | −1.38186E−02 | −3.16352E−04 | — | — |
| 6 | −0.89483 | −1.95366E+00 | −1.27469E−02 | 4.47141E−03 | 9.23859E−05 | −6.17900E−05 |
| 7 | −2.41142 | −3.51364E−01 | 2.29693E−02 | −1.14630E−03 | 2.13748E−04 | — |
| 8 | 2.36505 | −6.45547E+00 | 1.78157E−03 | −1.58889E−04 | 4.29882E−06 | |
| 9 | −32.8597 | −1.00000E+00 | 3.31078E−03 | −7.97871E−05 | −1.92159E−05 | 3.82592E−07 |

the focal length of the imaging lens array: f = 6.81, FNO = 4.0, HFOV = 28.7 deg
the first lens: f/f1 = 0.566
the second lens: f/f2 = 0.898, |R1/R2| = 1.998
the third lens: |f3/f| = 0.463, V3 = 26.6, t3 = 1.03 mm

What is claimed is:

1. An imaging lens array, successively from the object side, comprising a first lens, an aperture, a second lens, a third lens and a fourth lens;
the second lens is a biconvex glass lens with a convex surface facing forward and has a positive refractive power;
the third lens is a plastic made meniscus aspherical lens with a concave surface facing forward and has a negative refractive power;
the fourth lens is a plastic aspherical lens with a convex surface facing forward and has a positive refractive power;
the aperture is located between the first and second lenses and service to control brightness of the imaging lens array.

2. The imaging lens array as claimed in claim 1, wherein a front surface of the first lens is concave.

3. The imaging lens array as claimed in claim 2, wherein a rear surface of the first lens is convex.

4. The imaging lens array as claimed in claim 3, wherein a focal length of the first lens is f1, and a focal length of the imaging lens array is f, they satisfy an equation as: −0.5<|f/f1|<0.5.

5. The imaging lens array as claimed in claim 4, wherein the first lens has a positive refractive power.

6. The imaging lens array as claimed in claim 3, wherein the first lens is an aspherical lens made of plastic material.

7. The imaging lens array as claimed in claim 1, wherein a focal length of the second lens is f2 and the focal length of the imaging lens array is f, and they satisfy an equation as: 0.5<|f/f2|<2.0.

8. The imaging lens array as claimed in claim 7, wherein a radius of curvature of a front surface and a rear surface of the second lens are R1 and R2, and their relation are expressed as: |R1/R2|<0.5.

9. The imaging lens array as claimed in claim 1, wherein a rear surface of the third lens is convex.

10. The imaging lens array as claimed in claim 9, wherein a focal length of the third lens is f3 and the focal length of the imaging lens array is f, they satisfy the relation as: |f3/f|<1.0.

11. The imaging lens array as claimed in claim 10, wherein a color aberration of the third lens is V3 and a thickness of the third lens is t3, the V3 and t3 satisfy the following conditions:
0.5 mm<t3<2.0 mm; and
V3<35.

12. The imaging lens array as claimed in claim 1, wherein the first lens is a meniscus aspherical lens with a concave surface facing forward, a focal length of the first lens is f1, and a focal length of the imaging lens array is f, they satisfy an equation as: −0.5<|f/f1|<0.5;
the aperture is located behind the first lens;
the second lens is a biconvex glass lens, a focal length of the second lens is f2 and the focal length of the imaging lens array is f, and they satisfy an equation as: 0.5<|f/f2|<2.0; and a radius of curvature of a front surface and a rear surface of the second lens are R1 and R2, and their relation are expressed as: |R1/R2|<0.5;
the third lens is a plastic made meniscus aspherical lens with a concave surface facing forward, a focal length of the third lens is f3 and the focal length of the imaging lens array is f, they satisfy the relation as: |f3/f|<1.0, a color aberration of the third lens is V3 and a thickness of the third lens is t3, the V3 and t3 satisfy the following conditions: 5 mm<t3<2.0 mm; and V3<35; and
the fourth lens is a plastic aspherical lens with a convex surface facing forward, the third lens has a negative refractive power and the fourth lens has a positive refractive power.

13. The imaging lens array as claimed in claim 1, wherein
the first lens is a meniscus aspherical lens with a concave surface facing forward and has a positive refractive power, and both rear and front surfaces of the first lens are aspherical;
the second lens is a biconvex glass lens having a positive refractive power, and two opposite surfaces of the second lens are convex;
the third lens is a plastic made meniscus aspherical lens with a concave surface facing forward and has a negative refractive power, and two opposite surfaces of the third lens are aspherical;
the fourth lens is biconvex plastic lens having a positive refractive power, and both rear and front surfaces of the fourth lens are aspherical.
